(19) United States
(12) Patent Application Publication
(10) Pub. No.: US 2026/0239362 A1
(43) Pub. Date: Aug. 13, 2026

(54) MULTI-TRP OPERATION WITH UNIFIED TCI FRAMEWORK BEFORE INDICATING TCI STATES BY DCI

(71) Applicant: LENOVO (BEIJING) LIMITED, Beijing (CN)

(72) Inventors: Bingchao LIU, Beijing (CN); Chenxi ZHU, Fairfax, VA (US); Lingling XIAO, Beijing (CN); Yi ZHANG, Beijing (CN); Wei LING, Beijing (CN)

(21) Appl. No.: 19/152,519

(22) PCT Filed: Apr. 6, 2023
(86) PCT No.: PCT/CN2023/086619

§ 371 Date: Jul. 31, 2025

(51) Int. Cl. H04W 72/23; H04L 5/00

(52) U.S. Cl. CPC H04W 72/23; H04L 5/0094

(57) ABSTRACT

Methods and apparatuses for mutli-TRP operation with unified TCI framework are disclosed. In one embodiment, a UE comprises a transceiver; and a processor coupled to the transceiver, wherein the processor is configured to receive, via the transceiver, a MAC CE activating multiple TCI states for a BWP of a serving cell; and determine, at least for reception of PDSCH and PDCCH after application of the activated TCI states and before application of TCI states indicated by a DCI when unified TCI framework is configured, two activated DL TCI states from the activated multiple TCI states for the BWP of the serving cell.

### FIELD

The subject matter disclosed herein generally relates to wireless communications, and more particularly relates to methods and apparatuses for multiple transmission reception points (multi-TRP) operation with unified Transmission Configuration Indication (TCI) framework before indicating TCI states by downlink control information (DCI).

### BACKGROUND

Multi-TRP (M-TRP) operation with unified TCI framework is being specified in New Radio (NR) Release 18.

This invention targets behaviors of User Equipment (UE) and base unit (e.g., Next Generation Node B (gNB)) in M-TRP with unified TCI framework before indicating TCI states by DCI.

### BRIEF SUMMARY

Methods and apparatuses for mutli-TRP operation with unified TCI framework are disclosed.

In one embodiment, a UE comprises a transceiver; and a processor coupled to the transceiver, wherein the processor is configured to receive, via the transceiver, a MAC CE activating multiple TCI states for a BWP of a serving cell; and determine, at least for reception of PDSCH and PDCCH after application of the activated TCI states and before application of TCI states indicated by a DCI when unified TCI framework is configured, two activated DL TCI states from the activated multiple TCI states for the BWP of the serving cell.

In some embodiment, at least one TCI codepoint is mapped with two activated DL TCI states, and the processor is configured to determine that the two activated DL TCI states are mapped to the lowest TCI codepoint among the TCI codepoints mapped with two different DL TCI states. If a PDSCH is scheduled by a DCI containing a TCI selection field and a scheduling offset between the reception of PDCCH carrying the DCI and the reception of the PDSCH is less than a threshold, the processor is further configured to determine, as a default TCI state for the PDSCH reception, one of the two determined activated DL TCI states, or the TCI state or QCL assumptions used for PDCCH quasi co-location indication of the CORESET associated with a monitored search space with the lowest controlResourceSetId in the latest slot in which one or more CORESETs within the active BWP of the serving cell are monitored by the UE. The processor may be further configured to determine, from the two activated DL TCI states, one DL TCI state for reception of each CSI-RS resource configured in CSI resource set for CJT CSI measurement. If two CSI-RS resources are configured in CSI resource set for CJT CSI measurement, a first activated DL TCI state is applied to a first CSI-RS resource and a second activated DL TCI state is applied to a second CSI-RS resource. If three CSI-RS resources are configured in CSI resource set for CJT CSI measurement, the first activated TCI state is applied to a first CSI-RS resource and the second activated TCI state is applied to last two CSI-RS resources, or the first activated TCI state is applied to first two CSI-RS resources and the second activated TCI state is applied to a last CSI-RS resource. If four CSI-RS resources are configured in CSI resource set for CJT CSI measurement, the first activated TCI state is applied to first two CSI-RS resources and the second activated TCI state is applied to last two CSI-RS resources, or the first activated TCI state is applied to a first CSI-RS resource and the second activated TCI state is applied to last three CSI-RS resources, or the first activated TCI state is applied to first three CSI-RS resources and the second activated TCI state is applied to a last CSI-RS resource.

In some embodiment, at least one TCI codepoint is mapped with two activated UL TCI states, and the processor is further configured to determine, at least for transmission of PUSCH and PUCCH after application of the activated TCI states and before application of TCI states indicated by a DCI when unified TCI framework is configured, two activated UL TCI states mapped to the lowest TCI codepoint among the TCI codepoints mapped with two different UL TCI states. The processor may be further configured to determine UL TX spatial filter and a precoder for transmission of a scheduled PUSCH after receiving an initial higher layer configuration of TCI state list with multiple TCI states and before application of the activated TCI states, wherein, the UL TX spatial filter is the same as that for a PUSCH scheduled by RAR UL grant during initial access procedure, and the precoder is determined by a first TPMI field of the DCI scheduling the PUSCH and containing two TPMI fields for codebook transmission, and is determined by a first SRI field of the DCI scheduling the PUSCH and containing two SRI fields for non-codebook transmission. The processor may be further configured to transmit, via the transceiver, the scheduled PUSCH by SRS resource(s) within a first SRS resource set configured for codebook or non-codebook when two SRS resource sets for codebook or non-codebook are configured, after receiving the initial higher layer configuration of TCI state list and before application of the activated TCI states.

In some embodiment, the processor is further configured to determine, at least for transmission of PUSCH and PUCCH after receiving an initial higher layer configuration of TCI state list with multiple TCI states and before application of TCI states indicated by a DCI when unified TCI framework is configured, UL TX spatial filter and a precoder for transmission of a scheduled PUSCH, wherein, the UL TX spatial filter is the same as that for a PUSCH scheduled by RAR UL grant during initial access procedure, and the precoder is determined by a first TPMI field of the DCI scheduling the PUSCH and containing two TPMI fields for codebook transmission, and is determined by a first SRI field of the DCI scheduling the PUSCH and containing two SRI fields for non-codebook transmission.

In some embodiment, each TCI codepoint is associated with one of two coresetPoolIndex values and is mapped with one activated DL TCI state, and the processor is configured to determine that one of the two activated DL TCI states is the DL TCI state mapped to the lowest TCI codepoint among the TCI codepoints associated with one coresetPoolIndex value, and the other of the two activated DL TCI states is the DL TCI state mapped to the lowest TCI codepoint among the TCI codepoints associated with the other coresetPoolIndex value.

In some embodiment, each TCI codepoint is associated with one of two coresetPoolIndex values and is mapped with one activated UL TCI state, and the processor is further configured to determine, at least for transmission of PUSCH and PUCCH after application of the activated TCI states and before application of TCI states indicated by a DCI when unified TCI framework is configured, two activated UL TCI states, wherein, one of the two activated UL TCI states is the UL TCI state mapped to the lowest TCI codepoint among the TCI codepoints associated with one coresetPoolIndex value, and the other of the two activated UL TCI states is the UL TCI state mapped to the lowest TCI codepoint among the TCI codepoints associated with the other coresetPoolIndex value. The processor may be further configured to transmit, via the transceiver, a scheduled PUSCH by SRS resource(s) within a first SRS resource set configured for codebook or non-codebook when two SRS resource sets for codebook or non-codebook are configured, after receiving an initial higher layer configuration of TCI state list with multiple TCI states and before application of the activated TCI states.

In some embodiment, each TCI codepoint is associated with one of two coresetPoolIndex values and is mapped with one activated UL TCI state, and the processor is further configured to transmit, via the transceiver, a scheduled PUSCH by SRS resource(s) within a first SRS resource set configured for codebook or non-codebook when two SRS resource sets for codebook or non-codebook are configured for the UE, after receiving an initial higher layer configuration of TCI state list with multiple TCI states and before application of TCI states indicated by a DCI when unified TCI framework is configured.

In another embodiment, a method performed at a UE comprises receiving a MAC CE activating multiple TCI states for a BWP of a serving cell; and determining, at least for reception of PDSCH and PDCCH after application of the activated TCI states and before application of TCI states indicated by a DCI when unified TCI framework is configured, two activated DL TCI states from the activated multiple TCI states for the BWP of the serving cell.

In still another embodiment, a base unit comprises a transceiver; and a processor coupled to the transceiver, wherein the processor is configured to transmit, via the transceiver, a MAC CE activating multiple TCI states for a BWP of a serving cell of a UE; and determine, at least for transmission of PDSCH and PDCCH after application of the activated TCI states and before application of TCI states indicated by a DCI when unified TCI framework is configured, two activated DL TCI states from the activated multiple TCI states for the BWP of the serving cell of the UE.

In yet another embodiment, a method performed at a base unit comprises transmitting a MAC CE activating multiple TCI states for a BWP of a serving cell of a UE; and determining, at least for transmission of PDSCH and PDCCH after application of the activated TCI states and before application of TCI states indicated by a DCI when unified TCI framework is configured, two activated DL TCI states from the activated multiple TCI states for the BWP of the serving cell of the UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a procedure of configuration and indication of TCI state(s) for S-DCI based M-TRP operation;

FIG. 2 illustrates a procedure of configuration and indication of TCI state(s) for M-DCI based M-TRP operation;

FIG. 3 is a schematic flow chart diagram illustrating an embodiment of a method;

FIG. 4 is a schematic flow chart diagram illustrating an embodiment of another method; and

FIG. 5 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Single DCI (S-DCI) based M-TRP operation and multi-DCI (M-DCI) based M-TRP operation are described.

For S-DCI based M-TRP operation, a base unit (e.g., gNB) can send to a UE a DCI, in which two TCI states for the active bandwidth part (BWP) of a serving cell are indicated, where each TCI state corresponds to one TRP. To support larger bandwidth operation with lower UE implementation complexity, the bandwidth of a carrier can be divided into multiple BWPs, where each BWP corresponds to a part of bandwidth of the carrier.

FIG. 1 illustrates a procedure of configuration and indication of TCI state(s) for S-DCI based M-TRP operation.

Definitions of phase 1, phase 2 and phase 3 for S-DCI are described:

Phase 1: After a UE receives an initial higher layer configuration of dl-OrJoint-TCIStateList with more than one TCI state (where each TCI state can be TCI-State (which can be used as downlink (DL) TCI state or uplink (UL) TCI state) or TCI-UL-State (which can only be used as UL TCI state)) and before application of the TCI states activated by a Media Access Control (MAC) Control Element (CE), where at least one TCI codepoint is mapped with more than one TCI state, e.g., two TCI states or four TCI states. Two TCI modes are supported for unified TCI framework, i.e., joint TCI mode and separated TCI mode. For joint TCI mode, both DL TCI state and UL TCI state are indicated by TCI-State. For separate TCI mode, DL TCI state is indicated by TCI-State while UL TCI state is indicated by TCI-UL-State. The two TCI states can be a pair of TCI-States (each of which can be used as DL TCI state or UL TCI state), or a pair of TCI-UL-States (each of which can be used as UL TCI state); while the four TCI states can be a pair of TCI-States (each of which may be used as DL TCI state) and a pair of TCI-UL-States (each of which can be used as UL TCI state). In the following description, both TCI-State and TCI-UL-State are referred to as TCI state. When a TCI state is used as DL TCI state, the TCI state is TCI-State; and when a TCI state is used as UL TCI state, the TCI state can be either TCI-State or TCI-UL-State. DL TCI state is used for the UE to determine the DL RX spatial filter for DL reception and UL TCI state is used for the UE to determine the UL TX spatial filter.

In the example of FIG. 1, each TCI codepoint (e.g., TCI codepoint 0 to TCI codepoint 7) is mapped with one or two TCI states, where at least one TCI codepoint (e.g., TCI codepoint 2, 3, 5 or 6) is mapped with two TCI states. Each TCI codepoint corresponds to a TCI field value contained in DCI format 1_1 or DCI format 1_2.

Note that the application of the TCI states activated by a MAC CE begins from the first slot that is slot n+K, where the UE transmits a PUCCH with HARQ-ACK information (e.g., ACK) in slot n corresponding to the Physical Downlink Shared Channel (PDSCH) carrying the MAC CE and K is a predetermined value, e.g., 3.

Phase 2: After application of the TCI states (i.e., TCI codepoints) activated by the MAC CE and before application of one or two indicated TCI states (e.g., an indication of one TCI codepoint) from the activated TCI states (e.g., TCI codepoints).

A DCI carrying a TCI state indication indicates one or two TCI states from the activated TCI states. In particular, the DCI indicates one TCI codepoint mapped with one or two TCI states, which means that the one or two TCI states mapped to the one TCI codepoint are indicated. Note that the application of one or two indicated TCI states is the first slot that is at least beamAppTime symbols after the last symbol of the Physical Uplink Control Channel (PUCCH) or Physical Uplink Shared Channel (PUSCH) with Hybrid Automatic Repeat request-ACKnowledgement (HARQ-ACK) information (e.g., Acknowledgement (ACK)) corresponding to the DCI carrying the TCI state indication and without DL assignment, or corresponding to the PDSCH scheduled by the DCI carrying the TCI state indication and if the indicated TCI state is different from the previously indicated one. beamAppTime is a specific value configured according to UE capability.

Phase 3: after phase 2. For example, in phase 3, the TCI state(s) used for Physical Downlink Shared Channel (PDSCH) reception and Physical Downlink Control Channel (PDCCH) reception, which is transmitted from CORESET without dedicated configured TCI state, can be indicated by the TCI field of a DCI format 1_1 or 1_2, which may further includes a TCI selection field to indicate whether single TRP (S-TRP) or M-TRP PDSCH operation is performed. In S-DCI based S-TRP operation, the DCI schedules a PDSCH transmission by using one TRP. In S-DCI based M-TRP operation, the DCI schedules a PDSCH transmission by using multiple TRPs (e.g., two TRPs).

For S-DCI based M-TRP scenario with unified TCI framework specified in NR Release 17, S-TRP operation (e.g., based on synchronization signal block (SSB) identified during Random Access Channel (RACH) procedure) is assumed for both phase 1 and phase 2 in FIG. 1. However, it can be seen from FIG. 1 that S-DCI based M-TRP, which can improve transmission reliability, can be supported in phase 2. For example, if one of TCI codepoints 2, 3, 5 and 6 is selected to determine two TCI states, S-DCI based M-TRP can be supported in phase 2.

For M-DCI based M-TRP operation, each Control Resource Set (CORESET) is configured with a coresetPoolIndex value for TRP differential. Each CORESET corresponds to a set of time frequency resources for PDCCH transmission. For example, if there are two TRPs (e.g., TRP #0 and TRP #1), each of CORESET(s) for TRP #0 is configured with coresetPoolIndex value 0, and each of CORESET(s) for TRP #1 is configured with coresetPoolIndex value 1. Each TCI state is associated with a coresetPoolIndex value (e.g., 0 or 1). A base unit (e.g., gNB) can send from one TRP to a UE a DCI scheduling a PDSCH (i.e., PDSCH associated with a coresetPoolIndex value is transmitted from the TRP associated with the same coresetPoolIndex value). In case of two TRPs, the base unit can send from TRP #0 to a UE a first DCI scheduling PDSCH transmitted from TRP #0 and send from TRP #1 to the UE a second DCI scheduling PDSCH transmitted from TRP #1 in the same time and frequency resources.

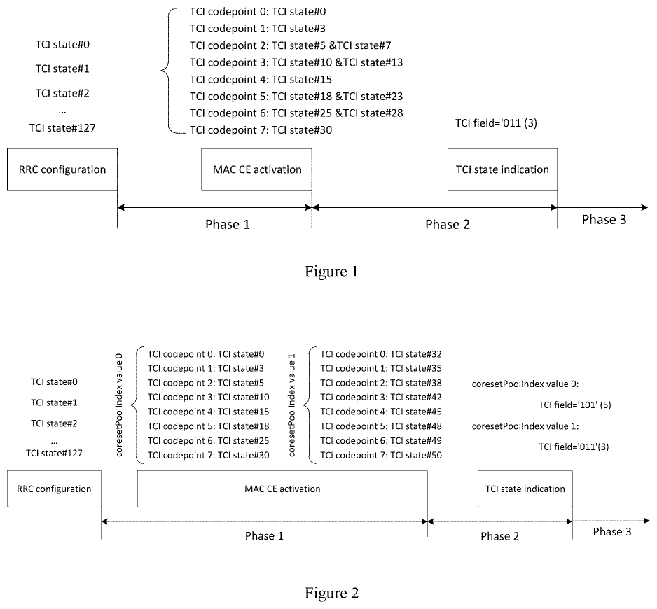

FIG. 2 illustrates a procedure of configuration and indication of TCI state(s) for M-DCI based M-TRP operation.

Definitions of phase 1, phase 2 and phase 3 for M-DCI are described:
Phase 1: After a UE receives an initial higher layer configuration of dl-OrJoint-TCIStateList with more than one TCI state (where each TCI state can be TCI-State or TCI-UL-State), where different (e.g., 2) coresetPoolIndex values are configured for the CORESETs in the BWP of a serving cell, and before application of the TCI states activated by a MAC CE, where different TCI States are activated for different coresetPoolIndex values.

In the example of FIG. 2, each TCI codepoint (e.g., TCI codepoint 0 to TCI codepoint 7) associated with one coresetPoolIndex value (e.g., coresetPoolIndex 0 or coresetPoolIndex 1) is mapped with one TCI state.

Phase 2: After application of the TCI states activated by the MAC CE and before application of one or two indicated TCI states from the activated TCI states.

Phase 3: after phase 2.

For M-DCI based M-TRP scenario with unified TCI framework specified in NR Release 17, S-TRP operation (e.g., based on SSB identified during RACH procedure) is assumed for both phase 1 and phase 2 in FIG. 2. However, it can be seen from FIG. 2 that M-DCI based M-TRP, which can improve system performance, can be supported in phase 2 by determine one TCI state for each TRP, i.e., for each coresetPoolIndex value (i.e., 0 or 1). For example, if one of TCI codepoints associated with coresetPoolIndex value 0 and one of TCI codepoints associated with coresetPoolIndex value 1 are selected, M-DCI based M-TRP can be supported in phase 2.

As a whole, for both S-DCI based M-TRP scenario and M-DCI based M-TRP scenario with unified TCI framework, M-TRP operation can be supported in phase 2. This disclosure proposes behaviors of UE and gNB in M-TRP with unified TCI framework in phase 1 and phase 2 (e.g., before phase 3 in which TCI state(s) are indicated by DCI).

A first embodiment relates to S-DCI based M-TRP.

A first sub-embodiment of the first embodiment relates to PDCCH and PDSCH in S-DCI based M-TRP.

A DCI transmitted from one or both TRPs (e.g. Single Frequency Network (SFN) PDCCH) may schedule one or multiple PDSCH transmissions from multiple TRPs (e.g., two TRPs) with the following schemes:

SFN scheme: two PDSCH transmissions are transmitted from two TRPs with the same time and frequency resources.

Space Division Multiplex (SDM) scheme: one PDSCH transmission is transmitted from two TRPs where different PDSCH layers are transmitted by different TRPs.

Time Division Multiplex (TDM) scheme: multiple PDSCH transmissions are transmitted from different TRPs in different time slots or mini-slots. A mini-slot corresponds to number of symbols within a slot, and one slot may have multiple mini-slots.

Frequency Division Multiplex (FDM) scheme: one PDSCH transmission is transmitted from two TRPs with different frequency resources or two PDSCH transmissions are transmitted from two TRPs with different frequency resources.

Dynamic switching between S-DCI based S-TRP and S-DCI based M-TRP can be supported by the TCI selection field contained in the scheduling DCI. For example, if the TCI selection field indicates ‘00’ or ‘01’, S-DCI based S-TRP is assumed; and if the TCI selection field indicates ‘10’, S-DCI based M-TRP is assumed.

S-TRP operation (i.e., S-DCI based S-TRP operation) is assumed in phase 1 for PDSCH and PDCCH. In particular, the UE assumes the Demodulation Reference Signal (DMRS) of PDSCH (and of PDCCH) are Quasi Co-Located (QCLed) with the Synchronization Signal and physical broadcast channel (SS/PBCH) block identified by the UE during the initial access. If the configuration of dl-OrJoint-TCIStateList is part of Reconfiguration with sync procedure, the UE assumes the DMRS of PDSCH (and of PDCCH) are QCLed with the SS/PBCH block identified by the UE during the random access procedure initiated by the Reconfiguration with sync procedure.

M-TRP operation (i.e., S-DCI based M-TRP operation) is assumed in phase 2 for PDSCH and PDCCH. In particular, the UE determines, at least for the UE supporting the capability of two default beams for S-DCI based M-TRP in frequency range 2 (FR2), the two TCI states (e.g., the two DL TCI states) mapped to the lowest TCI codepoint among the TCI codepoints mapped with two different TCI states for DL reception (e.g., two different DL TCI states). For example, if the TCI codepoints are activated as shown in FIG. 1, the lowest TCI codepoint among the TCI codepoints mapped with two different TCI states is TCI codepoint 2, which is mapped to TCI state #5 and TCI state #7. That is, TCI state #5 and TCI state #7 are determined in phase 2.

For PDCCH, the UE determines one or both TCI states (e.g., one or both TCI state #5 and TCI state #7) used for the PDCCH reception according to Radio Resource Control (RRC) configuration.

For PDSCH, when TCI selection field is configured in a DL DCI (e.g., DCI format 1_1 or 1_2), if a scheduling offset between the reception of the PDCCH carrying the DL DCI and a PDSCH scheduled by the DL DCI is equal to or larger than a threshold, the UE determines that one or both TCI states (e.g., one or both TCI state #5 and TCI state #7) are used for the PDSCH reception depending on the TCI selection field (for example, if the TCI selection field indicate ‘00’, the first TCI state (e.g., TCI state #5) is used, if the TCI selection field indicate ‘01’, the second TCI state (e.g., TCI state #7) is used, and if the TCI selection field indicate ‘10’, both TCI states (e.g., both TCI state #5 and TCI state #7) are used); and if the scheduling offset is less than the threshold, both TCI states (e.g., both TCI state #5 and TCI state #7) are used to receive (e.g., buffer) the PDSCH. The threshold is the minimum time duration for the UE to determine the QCL parameter for DL reception and the corresponding DCI decoding.

When TCI selection field is not configured in the scheduling DCI format 1_1 or 1_2, both TCI states are applied to the scheduled PDSCH. If the UE does not support the capability of two default beams for S-DCI based M-TRP in FR2, the UE shall assume S-TRP PDSCH.

When the scheduling offset between the reception of the PDCCH carrying the DL DCI (e.g., DCI format 1_1 or 1_2) containing a TCI selection field and a PDSCH scheduled by the DL DCI is less than the threshold, a default beam for the reception of the PDSCH can be determined with two options (option 11 and option 12). It is assumed that two TCI states are indicated by the TCI field of the DL DCI, e.g., in phase 3, or two TCI states are determined by the UE, e.g., in phase 2 (e.g., for TDM scheme), and the UE does not support the capability of two default beams for S-DCI based M-TRP in FR2.

Option 11: the UE shall use one of the indicated or determined TCI states for the PDSCH reception, e.g., the first indicated or determined TCI state or the second indicated or determined TCI state.

Option 12: the UE may assume that the DM-RS ports of the PDSCH(s) of the serving cell are QCLed with the RS(s) with respect to the first set of QCL parameter(s) used for PDCCH quasi co-location indication of the CORESET associated with a monitored search space with the lowest controlResourceSetId in the latest slot in which one or more CORESETs within the active BWP of the serving cell are monitored by the UE.

Single-DCI based M-TRP coherent joint transmission (CJT) PDSCH is being discussed in NR Release 18, where up to 4 TRPs can be used for a PDSCH transmission where each PDSCH layer is transmitted by all the coherent TRPs. For CJT CSI measurement, up to 4 channel state information reference signal (CSI-RS) resources can be configured in a channel state information (CSI) resource set for channel measurement, and each CSI-RS resource corresponds to a different TRP. To support CJT PDSCH transmission with up to 4 TRPs, it was agreed to indicate up to two TCI states (e.g., a first TCI state and a second TCI state) in a BWP of a serving cell to simplify the UE behavior. The gNB can indicate the UE to use the indicated TCI states for PDSCH for the CSI-RS reception at least for aperiodic CSI-RS. The TCI state for each CSI-RS resource can be determined in the following manner.

When two CSI-RS resources (e.g., a first CSI-RS resource, and a second CSI-RS resource) are configured in the CSI resource set for CJT CSI measurement, the first TCI state is applied to the first CSI-RS resource, and the second TCI state is applied to the second CSI-RS resource.

When three CSI-RS resources (e.g., a first CSI-RS resource, a second CSI-RS resource, and a third CSI-RS resource) are configured in the CSI resource sets for CJT CSI measurement, two options (option 21 and option 22) are provided:

Option 21: the first TCI state is applied to the first CSI-RS resource, and the second TCI state is applied to the last two CSI-RS resources (i.e., the second CSI-RS resource and the third CSI-RS resource).

Option 22: the first TCI state is applied to the first two CSI-RS resources (i.e., the first CSI-RS resource and the second CSI-RS resource); and the second TCI state is applied to the last CSI-RS resource (i.e., the third CSI-RS resource).

When four CSI-RS resources (e.g., a first CSI-RS resource, a second CSI-RS resource, a third CSI-RS resource, and a fourth CSI-RS resource) are configured in the CSI resource sets for CJT CSI measurement, three options (option 31, option 32 and option 32) are provided:

Option 31: The first TCI state is applied to the first two CSI-RS resources (i.e., the first CSI-RS resource and the second CSI-RS resource), and the second TCI state is applied to the last two CSI-RS resources (i.e., the third CSI-RS resource and the fourth CSI-RS resource).

Option 32: The first TCI state is applied to the first CSI-RS resource, and the second TCI state is applied to the last three CSI-RS resources (i.e., the second CSI-RS resource, the third CSI-RS resource and the fourth CSI-RS resource).

Option 33: The first TCI state is applied to the first three CSI-RS resources (i.e., the first CSI-RS resource, the second CSI-RS resource and the third CSI-RS resource), and the second TCI state is applied to the last CSI-RS resource (i.e., the fourth CSI-RS resource).

A second sub-embodiment of the first embodiment relates to PUCCH and PUSCH in S-DCI based M-TRP.

S-TRP operation (i.e., S-DCI based S-TRP operation) is assumed in phase 1 for PUSCH and PUCCH. The UL TX spatial filter for transmission of PUSCH, PUCCH and Sounding Reference Signal (SRS) is the same as that for a PUSCH scheduled by Random Access Response (RAR) UL grant during the initial access procedure. That is, the UE applies the UL beam used for PUSCH scheduled by RAR UL grant during the initial access procedure. For codebook transmission, when the scheduling DCI (e.g., DCI format 0_1 or 0_2) is configured with two transmitted precoding matrix indicator (TPMI) fields (e.g., a first TPMI field and a second TPMI field) and two SRS resource indicator (SRI) fields (e.g., a first SRI field and a second SRI field) and the UE is configured with two SRS resource sets (e.g., a first SRS resource set and a second SRS resource set) for codebook, the UE shall determine the TPMI for the scheduled PUSCH by the first TPMI field and determine the SRS resource for the scheduled PUSCH by the first SRI field, and the scheduled PUSCH is transmitted by the SRS resource within the first SRS resource set. That is, the precoder used for the scheduled PUSCH is determined by the first TPMI field. The scheduled PUSCH is transmitted with the SRS resource within the first SRS resource set indicated by the first SRI field by using the precoder indicated by the first TPMI field. It implies that the UE shall ignore the SRS resource set indicator field, the second TPMI field and the second SRI field. For non-codebook transmission, when the scheduling DCI (e.g., DCI format 0_1 or 0_2) is configured with two SRI fields (e.g., a first SRI field and a second SRI field) and the UE is configured with two SRS resource sets (e.g., a first SRS resource set and a second SRS resource set) for non-codebook, the UE shall determine the SRS resource(s) for the scheduled PUSCH by the first SRI field. That is, the precoder used for the scheduled PUSCH is determined by the first SRI field. It implies that the UE shall ignore the SRS resource set indicator field and the second SRI field. The first SRS resource set corresponds to the SRS resource set with lower set ID and the second SRS resource set corresponds to the SRS resource set with higher set ID.

M-TRP operation (i.e., S-DCI based M-TRP operation) is assumed in phase 2 for PUSCH and PUCCH. In particular, the UE determines the two TCI states (e.g., the two UL TCI states) mapped to the lowest TCI codepoint among the TCI codepoints mapped with two different TCI states for UL transmission (e.g., two different UL TCI states). For example, if the TCI codepoints are activated as shown in FIG. 1, the lowest TCI codepoint among the TCI codepoints mapped with two different TCI states is TCI codepoint 2, which is mapped to TCI state #5 and TCI state #7.

For PUCCH, the UE determines one or both TCI states (e.g., one or both TCI state #5 and TCI state #7) used for the PUCCH transmission according to a RRC parameter configured for each PUCCH resource or PUCCH resource group.

For PUSCH, the UE uses one or both TCI states to determine the UL TX spatial filter according to the SRS resource set indicator field and the PUSCH configuration of SFN PUSCH, SDM PUSCH, or TDM PUSCH. For example, if the UE is configured to support SDM PUSCH and the SRS resource set indicator field indicates ‘10’ to a scheduled PUSCH, the UE determines the UL TX spatial filter for the PUSCH layers to one TRP according to TCI state #5 and determines the UL TX spatial filter for the PUSCH layers to the other TRP according to TCI state #7.

Alternatively to S-DCI based M-TRP operation is assumed in phase 2 for PUSCH and PUCCH, S-DCI based S-TRP operation can be supported in phase 2. That is, the UL TX spatial filter for transmission of PUSCH, PUCCH and SRS in phase 2 is determined in the same manner as in phase 1, i.e., is the same as that for a PUSCH scheduled by Random Access Response (RAR) UL grant during the initial access procedure. In addition, the determination of TMPI and SRS resource in phase 2 for S-DCI based S-TRP operation is also the same as that in phase 1. That is, for codebook transmission, the scheduled PUSCH is transmitted with the SRS resource within the first SRS resource set indicated by the first SRI field by using the precoder indicated by the first TPMI field; and for non-codebook transmission, the scheduled PUSCH is transmitted with the SRS resource within the first SRS resource set indicated by the first SRI field by using the precoder determined by the first SRI field.

A second embodiment relates to M-DCI based M-TRP.

A first sub-embodiment of the second embodiment relates to PDCCH and PDSCH in M-DCI based M-TRP.

S-TRP operation (i.e., S-DCI based S-TRP operation) is assumed in phase 1 for PDSCH and PDCCH. In particular, the UE assumes the DMRS of PDSCH (and of PDCCH) are QCLed with the SS/PBCH block identified by the UE during the initial access. If the configuration of dl-OrJoint-TCIStateList is part of Reconfiguration with sync procedure, the UE assumes the DMRS of PDSCH (and of PDCCH) are QCLed with the SS/PBCH block identified by the UE during the random access procedure initiated by the Reconfiguration with sync procedure.

M-TRP operation (i.e., M-DCI based M-TRP operation) is assumed in phase 2 for PDSCH and PDCCH. In particular, the UE applies the TCI state (e.g., the UL TCI state) mapped to the lowest TCI codepoint for a coresetPoolIndex value, or the activated TCI state (e.g., the activated UL TCI state) with the lowest TCI State ID associated with a coresetPoolIndex value to the PDCCH and PDSCH reception associated with the same coresetPoolIndex value. For example, if the TCI codepoints are activated as shown in FIG. 2, the lowest TCI codepoint among the TCI codepoint for coresetPoolIndex value 0 is TCI state #0 (which also has the lowest TCI State ID among the activated TCI states associated with coresetPoolIndex value 0), and the lowest TCI codepoint among the TCI codepoint for coresetPoolIndex value 1 is TCI state #32 (which also has the lowest TCI State ID among the activated TCI states associated with coresetPoolIndex value 1).

So, the UE applies TCI-State #0 for the PDCCH reception transmitted from the CORESET associated with coresetPoolIndex value 0 and applies TCI-State #32 for the PDCCH reception transmitted from the CORESET associated with coresetPoolIndex value 1.

The UE applies TCI-State #0 for the reception of the PDSCH scheduled or activated by PDCCH transmitted from the CORESET associated with coresetPoolIndex value 0 and applies TCI-State #32 for the reception of the PDSCH scheduled or activated by PDCCH transmitted from the CORESET associated with coresetPoolIndex value 1.

A second sub-embodiment of the second embodiment relates to PUCCH and PUSCH in M-DCI based M-TRP.

S-TRP operation (i.e., M-DCI based S-TRP operation) is assumed in phase 1 for PUSCH and PUCCH. The UL TX spatial filter for transmission of PUSCH, PUCCH and SRS is the same as that for a PUSCH scheduled by RAR UL grant during the initial access procedure or the initial access procedure initiated by the Reconfiguration with sync procedure. When two SRS resource sets (e.g., a first SRS resource set and a second SRS resource set) for codebook or non-codebook are configured, the SRS resource(s) used for the scheduled PUSCH is selected from the first SRS resource set.

M-TRP operation (i.e., M-DCI based M-TRP operation) is assumed in phase 2 for PUSCH and PUCCH. In particular, the UE applies the TCI state (e.g., the UL TCI state) mapped to the lowest TCI codepoint associated with a coresetPoolIndex, or the activated TCI state with lower TCI state ID associated with a coresetPoolIndex to the transmission of PUSCH and PUCCH associated with the same coresetPoolIndex.

For example, The UE applies TCI state #0 for the PUCCH resources transmission associated with coresetPoolIndex value 0 and applies TCI state #32 for the PUCCH resources transmission associated with coresetPoolIndex value 1.

The UE applies TCI state #0 for the PUSCH scheduled or activated by PDCCH from the CORESET associated with coresetPoolIndex value 0 and applies TCI state #32 for the PUSCH scheduled or activated by PDCCH from the CORESET associated with coresetPoolIndex value 1.

Alternatively to M-DCI based M-TRP operation is assumed in phase 2 for PUSCH and PUCCH, M-DCI based S-TRP operation can be supported in phase 2. That is, the UL TX spatial filter for transmission of PUSCH, PUCCH and SRS in phase 2 is determined in the same manner as in phase 1, i.e., is the same as that for a PUSCH scheduled by RAR UL grant during the initial access procedure or the initial access procedure initiated by the Reconfiguration with sync procedure. In addition, when two SRS resource sets (e.g., a first SRS resource set and a second SRS resource set) for codebook or non-codebook are configured for the UE, the SRS resource(s) used for a scheduled PUSCH is selected from the first SRS resource set.

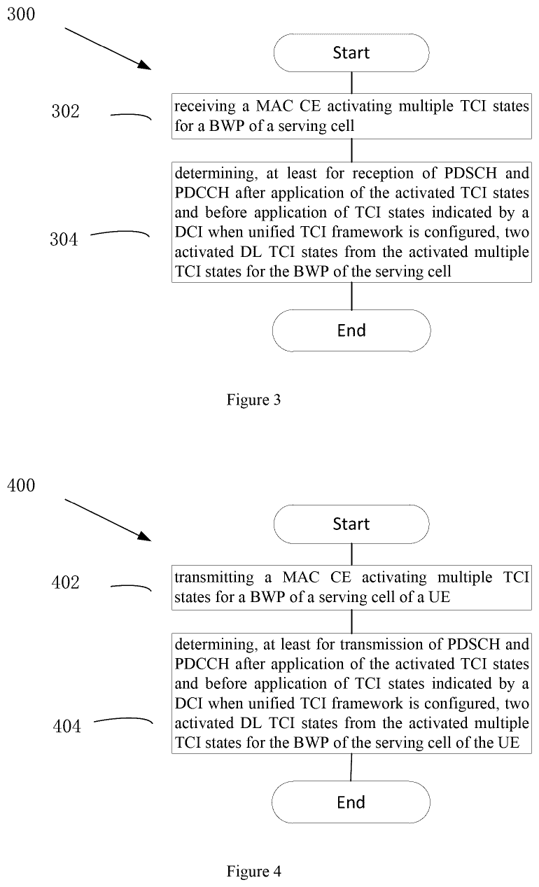

FIG. 3 is a schematic flow chart diagram illustrating an embodiment of a method 300 according to the present application. In some embodiments, the method 300 is performed by an apparatus, such as a remote unit (e.g. UE). In certain embodiments, the method 300 may be performed by a processor executing program code, for example, a microcontroller, a microprocessor, a CPU, a GPU, an auxiliary processing unit, a FPGA, or the like.

The method 300 is a method performed at a UE, comprising: 302 receiving a MAC CE activating multiple TCI states for a BWP of a serving cell; and 304 determining, at least for reception of PDSCH and PDCCH after application of the activated TCI states and before application of TCI states indicated by a DCI when unified TCI framework is configured, two activated DL TCI states from the activated multiple TCI states for the BWP of the serving cell.

In some embodiment, at least one TCI codepoint is mapped with two activated DL TCI states, and the method comprises determining that the two activated DL TCI states are mapped to the lowest TCI codepoint among the TCI codepoints mapped with two different DL TCI states. If a PDSCH is scheduled by a DCI containing a TCI selection field and a scheduling offset between the reception of PDCCH carrying the DCI and the reception of the PDSCH is less than a threshold, the method further comprises determining, as a default TCI state for the PDSCH reception, one of the two determined activated DL TCI states, or the TCI state or QCL assumptions used for PDCCH quasi co-location indication of the CORESET associated with a monitored search space with the lowest controlResourceSetId in the latest slot in which one or more CORESETs within the active BWP of the serving cell are monitored by the UE. The method may comprise determining, from the two activated DL TCI states, one DL TCI state for reception of each CSI-RS resource configured in CSI resource set for CJT CSI measurement. If two CSI-RS resources are configured in CSI resource set for CJT CSI measurement, a first activated DL TCI state is applied to a first CSI-RS resource and a second activated DL TCI state is applied to a second CSI-RS resource. If three CSI-RS resources are configured in CSI resource set for CJT CSI measurement, the first activated TCI state is applied to a first CSI-RS resource and the second activated TCI state is applied to last two CSI-RS resources, or the first activated TCI state is applied to first two CSI-RS resources and the second activated TCI state is applied to a last CSI-RS resource. If four CSI-RS resources are configured in CSI resource set for CJT CSI measurement, the first activated TCI state is applied to first two CSI-RS resources and the second activated TCI state is applied to last two CSI-RS resources, or the first activated TCI state is applied to a first CSI-RS resource and the second activated TCI state is applied to last three CSI-RS resources, or the first activated TCI state is applied to first three CSI-RS resources and the second activated TCI state is applied to a last CSI-RS resource.

In some embodiment, at least one TCI codepoint is mapped with two activated UL TCI states, and the method comprises determining, at least for transmission of PUSCH and PUCCH after application of the activated TCI states and before application of TCI states indicated by a DCI when unified TCI framework is configured, two activated UL TCI states mapped to the lowest TCI codepoint among the TCI codepoints mapped with two different UL TCI states. The method further comprises determining UL TX spatial filter and a precoder for transmission of a scheduled PUSCH after receiving an initial higher layer configuration of TCI state list with multiple TCI states and before application of the activated TCI states, wherein, the UL TX spatial filter is the same as that for a PUSCH scheduled by RAR UL grant during initial access procedure, and the precoder is determined by a first TPMI field of the DCI scheduling the PUSCH and containing two TPMI fields for codebook transmission, and is determined by a first SRI field of the DCI scheduling the PUSCH and containing two SRI fields for non-codebook transmission. The method further comprises transmitting the scheduled PUSCH by SRS resource(s) within a first SRS resource set configured for codebook or non-codebook when two SRS resource sets for codebook or non-codebook are configured, after receiving the initial higher layer configuration of TCI state list and before application of the activated TCI states.

In some embodiment, the method further comprises determining, at least for transmission of PUSCH and PUCCH after receiving an initial higher layer configuration of TCI state list with multiple TCI states and before application of TCI states indicated by a DCI when unified TCI framework is configured, UL TX spatial filter and a precoder for transmission of a scheduled PUSCH, wherein, the UL TX spatial filter is the same as that for a PUSCH scheduled by RAR UL grant during initial access procedure, and the precoder is determined by a first TPMI field of the DCI scheduling the PUSCH and containing two TPMI fields for codebook transmission, and is determined by a first SRI field of the DCI scheduling the PUSCH and containing two SRI fields for non-codebook transmission.

In some embodiment, each TCI codepoint is associated with one of two coresetPoolIndex values and is mapped with one activated DL TCI state, and the method comprises determining that one of the two activated DL TCI states is the DL TCI state mapped to the lowest TCI codepoint among the TCI codepoints associated with one coresetPoolIndex value, and the other of the two activated DL TCI states is the DL TCI state mapped to the lowest TCI codepoint among the TCI codepoints associated with the other coresetPoolIndex value.

In some embodiment, each TCI codepoint is associated with one of two coresetPoolIndex values and is mapped with one activated UL TCI state, and the method further comprises determining, at least for transmission of PUSCH and PUCCH after application of the activated TCI states and before application of TCI states indicated by a DCI when unified TCI framework is configured, two activated UL TCI states, wherein, one of the two activated UL TCI states is the UL TCI state mapped to the lowest TCI codepoint among the TCI codepoints associated with one coresetPoolIndex value, and the other of the two activated UL TCI states is the UL TCI state mapped to the lowest TCI codepoint among the TCI codepoints associated with the other coresetPoolIndex value. The method may further comprises transmitting a scheduled PUSCH by SRS resource(s) within a first SRS resource set configured for codebook or non-codebook when two SRS resource sets for codebook or non-codebook are configured, after receiving an initial higher layer configuration of TCI state list with multiple TCI states and before application of the activated TCI states.

In some embodiment, each TCI codepoint is associated with one of two coresetPoolIndex values and is mapped with one activated UL TCI state, and the method further comprises transmitting a scheduled PUSCH by SRS resource(s) within a first SRS resource set configured for codebook or non-codebook when two SRS resource sets for codebook or non-codebook are configured for the UE, after receiving an initial higher layer configuration of TCI state list with multiple TCI states and before application of TCI states indicated by a DCI when unified TCI framework is configured.

FIG. 4 is a schematic flow chart diagram illustrating an embodiment of a method 400 according to the present application. In some embodiments, the method 400 is performed by an apparatus, such as a base unit. In certain embodiments, the method 400 may be performed by a processor executing program code, for example, a microcontroller, a microprocessor, a CPU, a GPU, an auxiliary processing unit, a FPGA, or the like.

The method 400 may comprise 402 transmitting a MAC CE activating multiple TCI states for a BWP of a serving cell of a UE; and 404 determining, at least for transmission of PDSCH and PDCCH after application of the activated TCI states and before application of TCI states indicated by a DCI when unified TCI framework is configured, two activated DL TCI states from the activated multiple TCI states for the BWP of the serving cell of the UE.

In some embodiment, at least one TCI codepoint is mapped with two activated DL TCI states, and the method comprises determining that the two activated DL TCI states are mapped to the lowest TCI codepoint among the TCI codepoints mapped with two different DL TCI states. If a PDSCH is scheduled by a DCI containing a TCI selection field and a scheduling offset between the transmission of PDCCH carrying the DCI and the transmission of the PDSCH is less than a threshold, the method further comprises determining, as a default TCI state for the PDSCH transmission, one of the two determined activated DL TCI states, or the TCI state or QCL assumptions used for PDCCH quasi co-location indication of the CORESET associated with a monitored search space with the lowest controlResourceSetId in the latest slot in which one or more CORESETs within the active BWP of the serving cell are monitored by the UE. The method may further comprise determining, from the two activated DL TCI states, one DL TCI state for transmission of each CSI-RS resource configured in CSI resource set for CJT CSI measurement. If two CSI-RS resources are configured in CSI resource set for CJT CSI measurement, a first activated DL TCI state is applied to a first CSI-RS resource and a second activated DL TCI state is applied to a second CSI-RS resource. If three CSI-RS resources are configured in CSI resource set for CJT CSI measurement, the first activated TCI state is applied to a first CSI-RS resource and the second activated TCI state is applied to last two CSI-RS resources, or the first activated TCI state is applied to first two CSI-RS resources and the second activated TCI state is applied to a last CSI-RS resource. If four CSI-RS resources are configured in CSI resource set for CJT CSI measurement, the first activated TCI state is applied to first two CSI-RS resources and the second activated TCI state is applied to last two CSI-RS resources, or the first activated TCI state is applied to a first CSI-RS resource and the second activated TCI state is applied to last three CSI-RS resources, or the first activated TCI state is applied to first three CSI-RS resources and the second activated TCI state is applied to a last CSI-RS resource.

In some embodiment, at least one TCI codepoint is mapped with two activated UL TCI states, and the method further comprises determining, at least for reception of PUSCH and PUCCH after application of the activated TCI states and before application of TCI states indicated by a DCI when unified TCI framework is configured, two activated UL TCI states mapped to the lowest TCI codepoint among the TCI codepoints mapped with two different UL TCI states. The method further comprises determining UL RX spatial filter and a precoder for reception of a scheduled PUSCH after transmitting an initial higher layer configuration of TCI state list with multiple TCI states and before application of the activated TCI states, wherein, the UL RX spatial filter is the same as that for a PUSCH scheduled by RAR UL grant during initial access procedure of the UE, and the precoder is determined by a first TPMI field of the DCI scheduling the PUSCH and containing two TPMI fields for codebook transmission, and is determined by a first SRI field of the DCI scheduling the PUSCH and containing two SRI fields for non-codebook transmission. The method further comprises receiving the scheduled PUSCH by SRS resource(s) within a first SRS resource set configured for codebook or non-codebook when two SRS resource sets for codebook or non-codebook are configured, after transmitting the initial higher layer configuration of TCI state list and before application of the activated TCI states.

In some embodiment, the method further comprises determining, at least for reception of PUSCH and PUCCH after transmitting an initial higher layer configuration of TCI state list with multiple TCI states and before application of TCI states indicated by a DCI when unified TCI framework is configured, UL RX spatial filter and a precoder for reception of a scheduled PUSCH, wherein, the UL RX spatial filter is the same as that for a PUSCH scheduled by RAR UL grant during initial access procedure of the UE, and the precoder is determined by a first TPMI field of the DCI scheduling the PUSCH and containing two TPMI fields for codebook transmission, and is determined by a first SRI field of the DCI scheduling the PUSCH and containing two SRI fields for non-codebook transmission.

In some embodiment, each TCI codepoint is associated with one of two coresetPoolIndex values and is mapped with one activated DL TCI state, and the method comprises determining that one of the two activated DL TCI states is the DL TCI state mapped to the lowest TCI codepoint among the TCI codepoints associated with one coresetPoolIndex value, and the other of the two activated DL TCI states is the DL TCI state mapped to the lowest TCI codepoint among the TCI codepoints associated with the other coresetPoolIndex value.

In some embodiment, each TCI codepoint is associated with one of two coresetPoolIndex values and is mapped with one activated UL TCI state, and the method further comprises determining, at least for reception of PUSCH and PUCCH after application of the activated TCI states and before application of TCI states indicated by a DCI when unified TCI framework is configured, two activated UL TCI states, wherein, one of the two activated UL TCI states is the UL TCI state mapped to the lowest TCI codepoint among the TCI codepoints associated with one coresetPoolIndex value, and the other of the two activated UL TCI states is the UL TCI state mapped to the lowest TCI codepoint among the TCI codepoints associated with the other coresetPoolIndex value. The method may further comprises receiving a scheduled PUSCH by SRS resource(s) within a first SRS resource set configured for codebook or non-codebook when two SRS resource sets for codebook or non-codebook are configured, after transmitting an initial higher layer configuration of TCI state list with multiple TCI states and before application of the activated TCI states.

In some embodiment, each TCI codepoint is associated with one of two coresetPoolIndex values and is mapped with one activated UL TCI state, and the method further comprises receiving a scheduled PUSCH by SRS resource(s) within a first SRS resource set configured for codebook or non-codebook when two SRS resource sets for codebook or non-codebook are configured for the UE, after transmitting an initial higher layer configuration of TCI state list with multiple TCI states and before application of TCI states indicated by a DCI when unified TCI framework is configured.

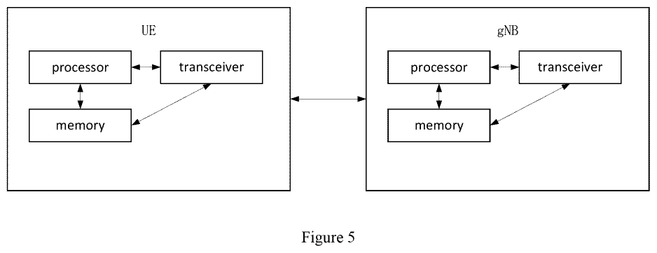

FIG. 5 is a schematic block diagram illustrating apparatuses according to one embodiment.

Referring to FIG. 5, the UE (i.e. the remote unit) includes a processor, a memory, and a transceiver. The processor implements a function, a process, and/or a method which are proposed in FIG. 3.

The UE comprises a transceiver; and a processor coupled to the transceiver, wherein the processor is configured to receive, via the transceiver, a MAC CE activating multiple TCI states for a BWP of a serving cell; and determine, at least for reception of PDSCH and PDCCH after application of the activated TCI states and before application of TCI states indicated by a DCI when unified TCI framework is configured, two activated DL TCI states from the activated multiple TCI states for the BWP of the serving cell.

In some embodiment, at least one TCI codepoint is mapped with two activated DL TCI states, and the processor is configured to determine that the two activated DL TCI states are mapped to the lowest TCI codepoint among the TCI codepoints mapped with two different DL TCI states. If a PDSCH is scheduled by a DCI containing a TCI selection field and a scheduling offset between the reception of PDCCH carrying the DCI and the reception of the PDSCH is less than a threshold, the processor is further configured to determine, as a default TCI state for the PDSCH reception, one of the two determined activated DL TCI states, or the TCI state or QCL assumptions used for PDCCH quasi co-location indication of the CORESET associated with a monitored search space with the lowest controlResourceSetId in the latest slot in which one or more CORESETs within the active BWP of the serving cell are monitored by the UE. The processor may be further configured to determine, from the two activated DL TCI states, one DL TCI state for reception of each CSI-RS resource configured in CSI resource set for CJT CSI measurement. If two CSI-RS resources are configured in CSI resource set for CJT CSI measurement, a first activated DL TCI state is applied to a first CSI-RS resource and a second activated DL TCI state is applied to a second CSI-RS resource. If three CSI-RS resources are configured in CSI resource set for CJT CSI measurement, the first activated TCI state is applied to a first CSI-RS resource and the second activated TCI state is applied to last two CSI-RS resources, or the first activated TCI state is applied to first two CSI-RS resources and the second activated TCI state is applied to a last CSI-RS resource. If four CSI-RS resources are configured in CSI resource set for CJT CSI measurement, the first activated TCI state is applied to first two CSI-RS resources and the second activated TCI state is applied to last two CSI-RS resources, or the first activated TCI state is applied to a first CSI-RS resource and the second activated TCI state is applied to last three CSI-RS resources, or the first activated TCI state is applied to first three CSI-RS resources and the second activated TCI state is applied to a last CSI-RS resource.

In some embodiment, at least one TCI codepoint is mapped with two activated UL TCI states, and the processor is further configured to determine, at least for transmission of PUSCH and PUCCH after application of the activated TCI states and before application of TCI states indicated by a DCI when unified TCI framework is configured, two activated UL TCI states mapped to the lowest TCI codepoint among the TCI codepoints mapped with two different UL TCI states. The processor may be further configured to determine UL TX spatial filter and a precoder for transmission of a scheduled PUSCH after receiving an initial higher layer configuration of TCI state list with multiple TCI states and before application of the activated TCI states, wherein, the UL TX spatial filter is the same as that for a PUSCH scheduled by RAR UL grant during initial access procedure, and the precoder is determined by a first TPMI field of the DCI scheduling the PUSCH and containing two TPMI fields for codebook transmission, and is determined by a first SRI field of the DCI scheduling the PUSCH and containing two SRI fields for non-codebook transmission. The processor may be further configured to transmit, via the transceiver, the scheduled PUSCH by SRS resource(s) within a first SRS resource set configured for codebook or non-codebook when two SRS resource sets for codebook or non-codebook are configured, after receiving the initial higher layer configuration of TCI state list and before application of the activated TCI states.

In some embodiment, the processor is further configured to determine, at least for transmission of PUSCH and PUCCH after receiving an initial higher layer configuration of TCI state list with multiple TCI states and before application of TCI states indicated by a DCI when unified TCI framework is configured, UL TX spatial filter and a precoder for transmission of a scheduled PUSCH, wherein, the UL TX spatial filter is the same as that for a PUSCH scheduled by RAR UL grant during initial access procedure, and the precoder is determined by a first TPMI field of the DCI scheduling the PUSCH and containing two TPMI fields for codebook transmission, and is determined by a first SRI field of the DCI scheduling the PUSCH and containing two SRI fields for non-codebook transmission.

In some embodiment, each TCI codepoint is associated with one of two coresetPoolIndex values and is mapped with one activated DL TCI state, and the processor is configured to determine that one of the two activated DL TCI states is the DL TCI state mapped to the lowest TCI codepoint among the TCI codepoints associated with one coresetPoolIndex value, and the other of the two activated DL TCI states is the DL TCI state mapped to the lowest TCI codepoint among the TCI codepoints associated with the other coresetPoolIndex value.

In some embodiment, each TCI codepoint is associated with one of two coresetPoolIndex values and is mapped with one activated UL TCI state, and the processor is further configured to determine, at least for transmission of PUSCH and PUCCH after application of the activated TCI states and before application of TCI states indicated by a DCI when unified TCI framework is configured, two activated UL TCI states, wherein, one of the two activated UL TCI states is the UL TCI state mapped to the lowest TCI codepoint among the TCI codepoints associated with one coresetPoolIndex value, and the other of the two activated UL TCI states is the UL TCI state mapped to the lowest TCI codepoint among the TCI codepoints associated with the other coresetPoolIndex value. The processor may be further configured to transmit, via the transceiver, a scheduled PUSCH by SRS resource(s) within a first SRS resource set configured for codebook or non-codebook when two SRS resource sets for codebook or non-codebook are configured, after receiving an initial higher layer configuration of TCI state list with multiple TCI states and before application of the activated TCI states.

In some embodiment, each TCI codepoint is associated with one of two coresetPoolIndex values and is mapped with one activated UL TCI state, and the processor is further configured to transmit, via the transceiver, a scheduled PUSCH by SRS resource(s) within a first SRS resource set configured for codebook or non-codebook when two SRS resource sets for codebook or non-codebook are configured for the UE, after receiving an initial higher layer configuration of TCI state list with multiple TCI states and before application of TCI states indicated by a DCI when unified TCI framework is configured.

The gNB (i.e. the base unit) includes a processor, a memory, and a transceiver. The processor implements a function, a process, and/or a method which are proposed in FIG. 4.

The base unit comprises a transceiver; and a processor coupled to the transceiver, wherein the processor is configured to transmit, via the transceiver, a MAC CE activating multiple TCI states for a BWP of a serving cell of a UE; and determine, at least for transmission of PDSCH and PDCCH after application of the activated TCI states and before application of TCI states indicated by a DCI when unified TCI framework is configured, two activated DL TCI states from the activated multiple TCI states for the BWP of the serving cell of the UE.

In some embodiment, at least one TCI codepoint is mapped with two activated DL TCI states, and the processor is configured to determine that the two activated DL TCI states are mapped to the lowest TCI codepoint among the TCI codepoints mapped with two different DL TCI states. If a PDSCH is scheduled by a DCI containing a TCI selection field and a scheduling offset between the transmission of PDCCH carrying the DCI and the transmission of the PDSCH is less than a threshold, the processor is further configured to determine, as a default TCI state for the PDSCH transmission, one of the two determined activated DL TCI states, or the TCI state or QCL assumptions used for PDCCH quasi co-location indication of the CORESET associated with a monitored search space with the lowest controlResourceSetId in the latest slot in which one or more CORESETs within the active BWP of the serving cell are monitored by the UE. The processer may be further configured to determine, from the two activated DL TCI states, one DL TCI state for transmission of each CSI-RS resource configured in CSI resource set for CJT CSI measurement. If two CSI-RS resources are configured in CSI resource set for CJT CSI measurement, a first activated DL TCI state is applied to a first CSI-RS resource and a second activated DL TCI state is applied to a second CSI-RS resource. If three CSI-RS resources are configured in CSI resource set for CJT CSI measurement, the first activated TCI state is applied to a first CSI-RS resource and the second activated TCI state is applied to last two CSI-RS resources, or the first activated TCI state is applied to first two CSI-RS resources and the second activated TCI state is applied to a last CSI-RS resource. If four CSI-RS resources are configured in CSI resource set for CJT CSI measurement, the first activated TCI state is applied to first two CSI-RS resources and the second activated TCI state is applied to last two CSI-RS resources, or the first activated TCI state is applied to a first CSI-RS resource and the second activated TCI state is applied to last three CSI-RS resources, or the first activated TCI state is applied to first three CSI-RS resources and the second activated TCI state is applied to a last CSI-RS resource.

In some embodiment, at least one TCI codepoint is mapped with two activated UL TCI states, and the processor is further configured to determine, at least for reception of PUSCH and PUCCH after application of the activated TCI states and before application of TCI states indicated by a DCI when unified TCI framework is configured, two activated UL TCI states mapped to the lowest TCI codepoint among the TCI codepoints mapped with two different UL TCI states. The processor is further configured to determine UL RX spatial filter and a precoder for reception of a scheduled PUSCH after transmitting an initial higher layer configuration of TCI state list with multiple TCI states and before application of the activated TCI states, wherein, the UL RX spatial filter is the same as that for a PUSCH scheduled by RAR UL grant during initial access procedure of the UE, and the precoder is determined by a first TPMI field of the DCI scheduling the PUSCH and containing two TPMI fields for codebook transmission, and is determined by a first SRI field of the DCI scheduling the PUSCH and containing two SRI fields for non-codebook transmission. The processor may be further configured to receive, via the transceiver, the scheduled PUSCH by SRS resource(s) within a first SRS resource set configured for codebook or non-codebook when two SRS resource sets for codebook or non-codebook are configured, after transmitting the initial higher layer configuration of TCI state list and before application of the activated TCI states.

In some embodiment, the processor is further configured to determine, at least for reception of PUSCH and PUCCH after transmitting an initial higher layer configuration of TCI state list with multiple TCI states and before application of TCI states indicated by a DCI when unified TCI framework is configured, UL RX spatial filter and a precoder for reception of a scheduled PUSCH, wherein, the UL RX spatial filter is the same as that for a PUSCH scheduled by RAR UL grant during initial access procedure of the UE, and the precoder is determined by a first TPMI field of the DCI scheduling the PUSCH and containing two TPMI fields for codebook transmission, and is determined by a first SRI field of the DCI scheduling the PUSCH and containing two SRI fields for non-codebook transmission.

In some embodiment, each TCI codepoint is associated with one of two coresetPoolIndex values and is mapped with one activated DL TCI state, and the processor is configured to determine that one of the two activated DL TCI states is the DL TCI state mapped to the lowest TCI codepoint among the TCI codepoints associated with one coresetPoolIndex value, and the other of the two activated DL TCI states is the DL TCI state mapped to the lowest TCI codepoint among the TCI codepoints associated with the other coresetPoolIndex value.

In some embodiment, each TCI codepoint is associated with one of two coresetPoolIndex values and is mapped with one activated UL TCI state, and the processor is further configured to determine, at least for reception of PUSCH and PUCCH after application of the activated TCI states and before application of TCI states indicated by a DCI when unified TCI framework is configured, two activated UL TCI states, wherein, one of the two activated UL TCI states is the UL TCI state mapped to the lowest TCI codepoint among the TCI codepoints associated with one coresetPoolIndex value, and the other of the two activated UL TCI states is the UL TCI state mapped to the lowest TCI codepoint among the TCI codepoints associated with the other coresetPoolIndex value. The processor may be further configured to receive, via the transceiver, a scheduled PUSCH by SRS resource(s) within a first SRS resource set configured for codebook or non-codebook when two SRS resource sets for codebook or non-codebook are configured, after transmitting an initial higher layer configuration of TCI state list with multiple TCI states and before application of the activated TCI states.

In some embodiment, each TCI codepoint is associated with one of two coresetPoolIndex values and is mapped with one activated UL TCI state, and the processor is further configured to receiver, via the transceiver, a scheduled PUSCH by SRS resource(s) within a first SRS resource set configured for codebook or non-codebook when two SRS resource sets for codebook or non-codebook are configured for the UE, after transmitting an initial higher layer configuration of TCI state list with multiple TCI states and before application of TCI states indicated by a DCI when unified TCI framework is configured.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a media access control (MAC) control element (CE) activating multiple transmission configuration identifier (TCI) states for a bandwidth partition (BWP) of a serving cell; and
determine, at least for reception of physical downlink shared channel (PDSCH) and physical downlink control channel (PDCCH) after application of the activated TCI states and before application of TCI states indicated by a downlink control information (DCI) when a unified TCI framework is configured, two activated DL TCI states from the activated multiple TCI states for the BWP of the serving cell.

2. The UE of claim 1, wherein at least one TCI codepoint is mapped with two activated downlink (DL) TCI states, and
wherein the at least one processor is configured to cause the UE to determine that the two activated DL TCI states are mapped to a lowest TCI codepoint among the TCI codepoints mapped with two different DL TCI states.

3. The UE of claim 2, wherein,
if a PDSCH is scheduled by a DCI containing a TCI selection field and a scheduling offset between the reception of PDCCH carrying the DCI and the reception of the PDSCH is less than a threshold, the at least one processor is further configured to cause the UE to determine, as a default TCI state for the PDSCH reception, one of the two determined activated DL TCI states, or the TCI state or quasi-colocation (QCL) assumptions used for PDCCH QCL indication of a control resource set (CORESET) associated with a monitored search space with a lowest controlResourceSetId in a latest slot in which one or more CORESETs within the active BWP of the serving cell are monitored by the UE.

4. The UE of claim 2, wherein
the at least one processor is further configured to cause the UE to determine, from the two activated DL TCI states, one DL TCI state for reception of each channel state information reference signal (CSI-RS) resource configured in a CSI resource set for a coherent joint transmission (CJT) CSI measurement.

5. The UE of claim 4, wherein,
if two CSI-RS resources are configured in the CSI resource set for the CJT CSI measurement, a first activated DL TCI state is applied to a first CSI-RS resource and a second activated DL TCI state is applied to a second CSI-RS resource;
if three CSI-RS resources are configured in the CSI resource set for the CJT CSI measurement, the first activated TCI state is applied to a first CSI-RS resource and the second activated TCI state is applied to last two CSI-RS resources, or the first activated TCI state is applied to first two CSI-RS resources and the second activated TCI state is applied to a last CSI-RS resource; and
if four CSI-RS resources are configured in the CSI resource set for the CJT CSI measurement, the first activated TCI state is applied to first two CSI-RS resources and the second activated TCI state is applied to last two CSI-RS resources, or the first activated TCI state is applied to a first CSI-RS resource and the second activated TCI state is applied to last three CSI-RS resources, or the first activated TCI state is applied to first three CSI-RS resources and the second activated TCI state is applied to a last CSI-RS resource.

6. The UE of claim 1, wherein at least one TCI codepoint is mapped with two activated uplink (UL) TCI states, and
wherein the at least one processor is further configured to cause the UE to determine, at least for transmission of physical uplink shared channel (PUSCH) and physical uplink control channel (PUCCH) after application of the activated TCI states and before application of TCI states indicated by a DCI when a unified TCI framework is configured, two activated UL TCI states mapped to the lowest TCI codepoint among the TCI codepoints mapped with two different UL TCI states.

7. The UE of claim 6, wherein
the at least one processor is further configured to cause the UE to determine a UL transmission (TX) spatial filter and a precoder for transmission of a scheduled PUSCH after receiving an initial higher layer configuration of TCI state list with multiple TCI states and before application of the activated TCI states,
wherein, the UL TX spatial filter is the same as that for a PUSCH scheduled by a random access response (RAR) UL grant during an initial access procedure, and
the precoder is determined by a first transmit precoding matrix indicator (TPMI) field of the DCI scheduling the PUSCH and containing two TPMI fields for codebook transmission, and is determined by a first sounding reference signal (SRS) resource indicator (SRI) field of the DCI scheduling the PUSCH and containing two SRI fields for non-codebook transmission.

8. The UE of claim 7, wherein
the at least one processor is further configured to cause the UE to transmit the scheduled PUSCH by SRS resources within a first SRS resource set configured for codebook or non-codebook when two SRS resource sets for codebook or non-codebook are configured, after receiving the initial higher layer configuration of TCI state list and before application of the activated TCI states.

9. The UE of claim 1, wherein
the at least one processor is further configured to cause the UE to determine, at least for transmission of physical uplink shared channel (PUSCH) and physical uplink control channel (PUCCH) after receiving an initial higher layer configuration of TCI state list with multiple TCI states and before application of TCI states indicated by a DCI when unified TCI framework is configured, an uplink transmission (TX) spatial filter and a precoder for transmission of a scheduled PUSCH,
wherein the UL TX spatial filter is the same as that for a PUSCH scheduled by a random access response (RAR) UL grant during initial access procedure, and
the precoder is determined by a first transmit precoding matrix indicator (TPMI) field of the DCI scheduling the PUSCH and containing two TPMI fields for codebook transmission, and is determined by a first sounding reference signal (SRS) resource indicator (SRI) field of the DCI scheduling the PUSCH and containing two SRI fields for non-codebook transmission.

10. The UE of claim 1, wherein each TCI codepoint is associated with one of two coresetPoolIndex values and is mapped with one activated downlink (DL) TCI state, and
wherein the at least one processor is configured to cause the UE to determine that one of the two activated DL TCI states is the DL TCI state mapped to the lowest TCI codepoint among the TCI codepoints associated with one coresetPoolIndex value, and the other of the two activated DL TCI states is the DL TCI state mapped to the lowest TCI codepoint among the TCI codepoints associated with the other coresetPoolIndex value.

11. The UE of claim 1, wherein each TCI codepoint is associated with one of two coresetPoolIndex values and is mapped with one activated uplink (UL) TCI state, and
wherein the at least one processor is further configured to cause the UE to determine, at least for transmission of physical uplink shared channel (PUSCH) and physical uplink control channel (PUCCH) after application of the activated TCI states and before application of TCI states indicated by a DCI when unified TCI framework is configured, two activated UL TCI states, wherein, one of the two activated UL TCI states is the UL TCI state mapped to the lowest TCI codepoint among the TCI codepoints associated with one coresetPoolIndex value, and the other of the two activated UL TCI states is the UL TCI state mapped to the lowest TCI codepoint among the TCI codepoints associated with the other coresetPoolIndex value.

12. The UE of claim 11, wherein the at least one processor is further configured to cause the UE to transmit a scheduled physical uplink shared channel (PUSCH) by sounding reference signal (SRS) resources within a first SRS resource set configured for codebook or non-codebook when two SRS resource sets for codebook or non-codebook are configured, after receiving an initial higher layer configuration of TCI state list with multiple TCI states and before application of the activated TCI states.

13. The UE of claim 1, wherein each TCI codepoint is associated with one of two coresetPoolIndex values and is mapped with one activated uplink (UL) TCI state, and
wherein the at least one processor is further configured to cause the UE to transmit a scheduled physical uplink shared channel (PUSCH) by sounding reference signal (SRS) resources within a first SRS resource set configured for codebook or non-codebook when two SRS resource sets for codebook or non-codebook are configured for the UE, after receiving an initial higher layer configuration of TCI state list with multiple TCI states and before application of TCI states indicated by a DCI when unified TCI framework is configured.

14-15. (canceled)

16. A user equipment (UE) for wireless communication, comprising:
at least one memory; and
at least one processor coupled with the at least one memory and configured to cause the UE to:
receive downlink control information (DCI) indicating a transmission configuration indicator (TCI) field codepoint mapped with two TCI states for a bandwidth partition (BWP) of a serving cell;
receive DCI scheduling a physical downlink shared channel (PDSCH) with a scheduling offset between a reception of the DCI and the scheduled PDSCH reception being less than a threshold; and
determine a first TCI state or a second TCI state of the two TCI states for the scheduled PDSCH reception when the UE does not support a capability of two default beams.

17. A base unit for wireless communication, comprising:
at least one memory; and
at least one processor coupled with the at least one memory and configured to cause the base unit to:
transmit downlink control information (DCI) indicating a transmission configuration indicator (TCI) field codepoint mapped with two TCI states for a bandwidth partition (BWP) of a serving cell; and
transmit DCI scheduling a physical downlink shared channel (PDSCH) with a scheduling offset between a reception of the DCI and the scheduled PDSCH reception being less than a threshold.

18. A method performed by a user equipment (UE), the method comprising:
receiving downlink control information (DCI) indicating a transmission configuration indicator (TCI) field codepoint mapped with two TCI states for a bandwidth partition (BWP) of a serving cell;
receiving DCI scheduling a physical downlink shared channel (PDSCH) with a scheduling offset between a reception of the DCI and the scheduled PDSCH reception being less than a threshold; and
determining a first TCI state or a second TCI state of the two TCI states for the scheduled PDSCH reception when the UE does not support a capability of two default beams.
